(19) United States
(12) Patent Application Publication
(10) Pub. No.: US 2014/0223010 A1
(43) Pub. Date: Aug. 7, 2014

(54) Data Compression and Encryption in Sensor Networks

(71) Applicant: David Alan Hayner, Austin, TX (US)

(72) Inventor: David Alan Hayner, Austin, TX (US)

(21) Appl. No.: 13/757,150

(22) Filed: Feb. 1, 2013

(51) Int. Cl. H04L 12/911; H04L 29/06

(52) U.S. Cl. CPC H04L 47/783; H04L 29/0604
USPC 709/226; 709/247

(57) ABSTRACT

Apparatus and methods for the collection, processing, storage, communication and use of data generated by an array of sensors connected to some physical structure in which bandwidth allocation methods are used in response to known and predictable propagation of signal events through the network. Use of these data allocation methods further enable the efficient use of data compression and encryption techniques.

### CROSS-REFERENCE TO RELATED APPLICATIONS

Provisional Utility Patent Application, Data Compression and Encryption in Sensor Networks, Application No. 61/593,907 Filing Date Feb. 2, 2012, Attorney Docket Number DH_{—}15_{—}006_P

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field addressing applications of sensors. More specifically, this invention discloses the employment of one or more sensors, digital processing systems and storage or communications devices to efficiently and securely collect and manage data flow over a network of distributed sensors.

The data collected by a network of sensors can be used to better understand the dynamics and operations of the structure or system on which this sensor network is attached. As the number of sensors increase, the potential amount of data flowing can impose unwanted latencies in delivery or economically unappealing increases in the cost of the communications networks. Additionally, data collected by this sensor network can be used to control various operations in the system to enhance the economic efficiency of the system on which this sensor network is attached. In order to protect the operations of the system, it may be desirable to encrypt the data to protect un-authorized use. Furthermore, other desirable features and characteristics of the embodiments presented here will become apparent from the subsequent detailed description taken in conjunction with the accompanying drawings and this background.

### SUMMARY OF THE INVENTION

The present invention employs an array of sensors, microprocessors, storage media and communications systems to efficiently and securely collect data from a network of sensors.

### BRIEF DESCRIPTION OF THE DRAWINGS

Various embodiments will hereinafter be described in conjunction with the following figures, wherein like numerals denote like elements, and

FIG. 1 is a diagram of a network of sensors, processors, storage and communications systems and sub-elements in the sensor devices configured in accordance with one embodiment of the invention;

FIG. 2 is a diagram of a network of sensors illustrating data flow issues associated with these structures in accordance with one embodiment of the invention;

FIG. 3 is a diagram of a network of sensors deployed on a structure illustrating exploitation of the finite propagation time of signals in a media to enable controlled data compression and/or encryption in accordance with one embodiment of the invention;

FIG. 4 is a set of data rate versus time diagrams illustrating various characteristics of data flow in this system in accordance with one embodiment of the invention;

FIG. 5 is a diagram of an alternate network of sensors distributed across the surface of a structure illustrating the methods discussed in this patent in accordance with one embodiment of the invention;

FIG. 6 is a diagram of the electrical connections of the physical structure illustrated in FIG. 5 in accordance with one embodiment of the invention.

### DETAILED DESCRIPTION OF EMBODIMENTS

The following detailed description is merely exemplary in nature and is not intended to limit the scope or the application and uses of the described embodiments. Furthermore, there is no intention to be bound by any theory presented in the preceding background or the following detailed description.

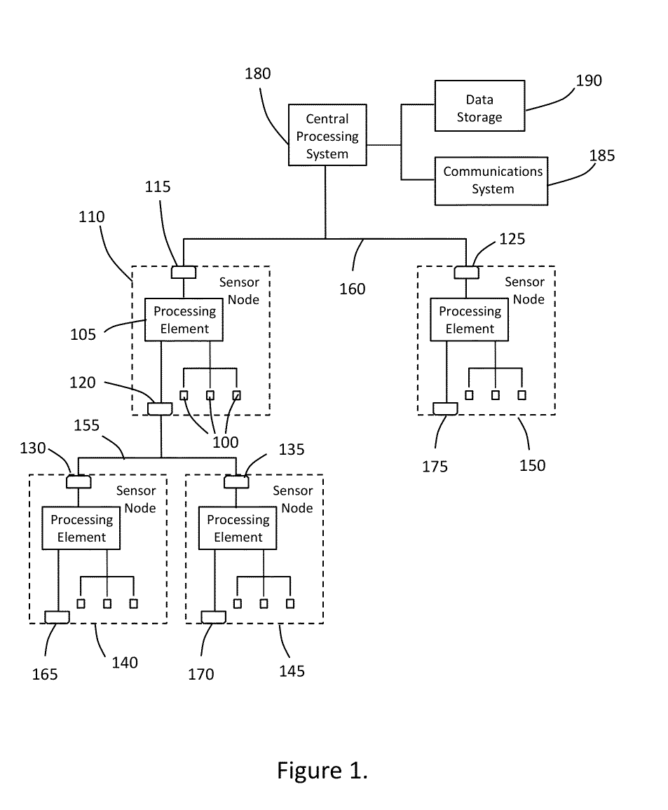

Referring now to the invention, FIG. 1 illustrates multiple sensors arranged in a network structure. The primary unit in this structure is a sensor node 110 consisting of one or more sensors 100, a processing element 105 and communications interfaces 115 and 120. This structure can be employed in parallel and serially to build a variety of physical structures containing arbitrary numbers of sensors. One possible structure is illustrated in FIG. 1. In this structure, the central processing system 180 has two sensors nodes 110 and 150 connected via communications bus 160 to central processing system 180. Central processing system 180 is connected to data storage 190 and communications system 185. Sensor node 110 has sensor nodes 145 and 140 as daughters and is connected via communications bus 155. In addition to collecting data from sensors 100, sensor node 110 receives sensor data from daughter nodes 140 and 145 via communications interface 120 connected to bus 155. Sensor node 110 can process, compress and/or encrypt various elements of this data and pass some, all, or the results of processing this data on to the central processing system 180 via communications interface 115 and bus 160.

While not illustrated in FIG. 1, sensor nodes 140, 145 and 150 could be connected to additional daughter sensor nodes via communications interfaces 165, 170 and 175 respectively. This hierarchy can continue arbitrarily both in depth and breadth. Further, this sensor structure is not limited to tree structures. Additional, possibly redundant connections may also be provided to ease communications requirements or provide alternate paths for data and commands. Alternately, these sensor nodes, 140, 145 and 150 may not have communications interfaces 165, 170 and 175 respectively.

These sensors 100 may consist of accelerometers, gyroscopes, pressure, acoustic, temperature, magnetic, optical, torsion, tension, force or other such measures of motion, applied forces and deformation. These sensors 100 may be arranged in any number of combinations, structures and relationships. The communications buses may be any of a number of methods currently available or that may become available in the future. The methods taught in this patent are substantially independent of the specific sensors employed, the bus and communications details.

Data generated by this sensor network and passed to the central processing system 180 may be used immediately for various purposes, stored for later use in data storage 190 and/or communicated to other systems via communications system 185.

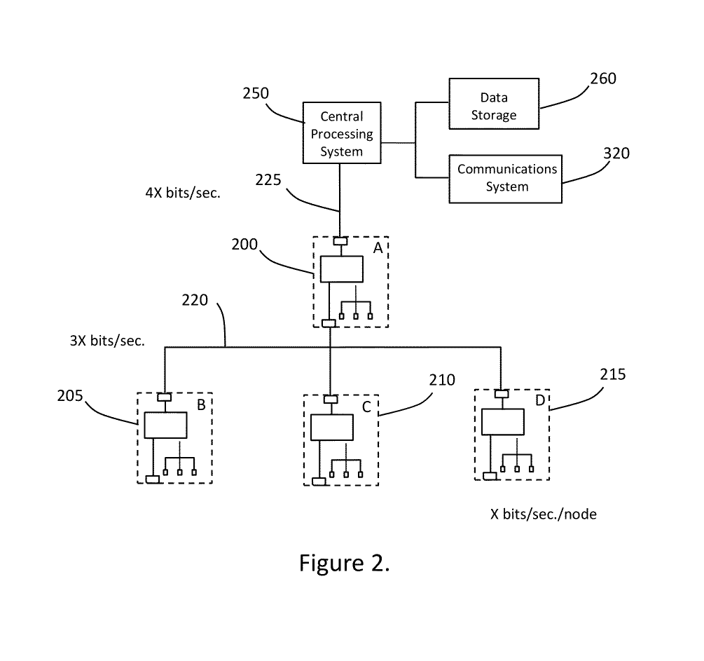

FIG. 2 illustrates a sensor network of 4 sensor nodes: Node A 200, Node B 205, Node C 210 and Node D 215. Each of the sensor nodes can generate up to X bits/second (bps) of data. In this case, up to 3X bits/sec (bps) of data will be on bus 220 and 4X bps of data will be on bus 225. As can be seen from this simple example, the amount of data that must be managed can grow quickly as the structure concentrates data. Other structural arrangements of sensor nodes 200, 205, 210, 215 are certainly possibly, but ultimately, 4X bps of data may flow on a bus to central processing system 250, independent of interconnect details. In this patent application, the amount of data transmitted by a device or carried on a bus per unit of time will be referred to as data rate or bandwidth.

The example of FIG. 2 is intended to illustrate the basic issue. In practical sensor networks, tens to hundreds of sensors or sensor nodes may be employed and the ratio of data flow over various busses in the network could vary by factors of a 100:1 to 1000:1 versus the 4:1 ratio in this example. In general, it may not be economically practical to provide these high communication rates. Methods are required to substantially reduce the data rate requirements on the networks in order to make sensor arrays economically useful. This patent disclosure will discuss methods that can more efficiently utilize available data communication capacity and thus enable the use of larger arrays of sensors or sensor nodes.

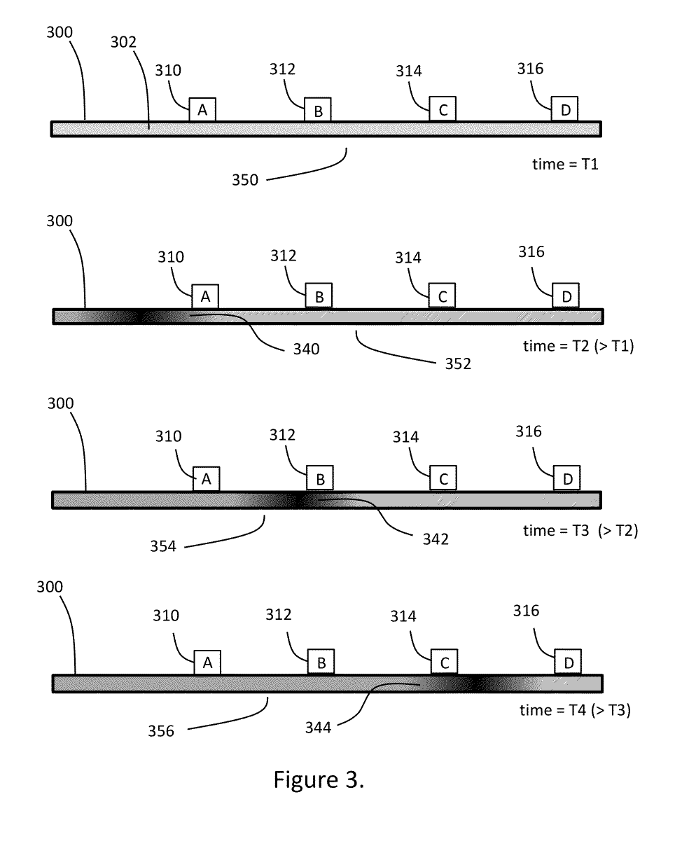

Reconsider the sensor array illustrated in FIG. 2 in which the communications buses 220 and 225 are limited to 2X bps data rate. Further, assume the four sensor nodes A 200, B 205, C 210 and D 215 of FIG. 2 are physically deployed along a structure 300 as illustrated in the various drawings in FIG. 3 as sensor nodes 310 A, 312 B, 314 C, and 316 D. Each sensor node has a maximum data generation rate from internal and/or associated sensors of X bps. Physical electrical interconnections are omitted from FIG. 3 to simply the drawings but the sensors nodes A, B, C and D are connected as illustrated in FIG. 2. In FIG. 3, the representative structure is a pipeline.

With reference to FIG. 3, view 350, consider material flowing at a constant rate in the pipeline 300 as illustrated by the constant gray scale 302. In this steady-state condition, the data collected by each of the sensors A 310, B 412, C 414 and D 416 may each be different, but each will tend to be statistically stationary or substantially invariant over some period of time. In this steady-state condition, each of the sensor nodes A, B, C and D may not need to use all of the X bps rate available to communicate this lack of change in signal content. Each node could use a lower data rate, Y bps, (=0.2 X bps for the purpose of explanation) to communicate the lack of change or small changes in information. In this steady-state condition, each sensor node generates 0.2X bps and sensor node A 220 must communicate 0.8X bps to the central processing system 250 in FIG. 2.

Now consider FIG. 3, view 352 in which a change in the density of the media in pipeline 300 occurs at time T2>T1. This change in density is indicated by the change in gray scale 340. At time T1, (FIG. 3, view 350) sensor nodes A, B, C and D are in steady-state conditions and each are consuming Y bps to communicate this substantially invariant data to the central processing system. At time T2 in FIG. 3, view 352, the change in density transition is starting to pass by sensor node A. Data collected by sensor node A is transitioning from stead-state conditions as illustrated in FIG. 3 view 350, to a transition period illustrated in FIG. 3, view 352 at time T2. In FIG. 3, view 354, the density transition, indicated by the change in gray scale 342 has passed sensor node A and sensor node A is back into a (possibly) new, but substantially steady-state condition at time T3. This new steady-state condition continues for sensor node A. As this density transition moves by sensor node A, the bandwidth required to communicate the change in information may increase, possibly up to the maximum of X bps. Once this density transition has passed sensor node A, this region of the pipeline returns to a (possibly) new steady-state condition and sensor node A can communicate this unchanging condition with Y bps (=0.2X bps).

As illustrated in FIG. 3 view 354 at time T3 with the density pulse 342 near sensor B and view 356 at time T4 with the density pulse 344 near sensor C, this density wave continues down the pipeline forcing each of the sensor nodes to into a higher data transmission mode (X bps) for a period of time, and then back to the steady-state rate of Y bps.

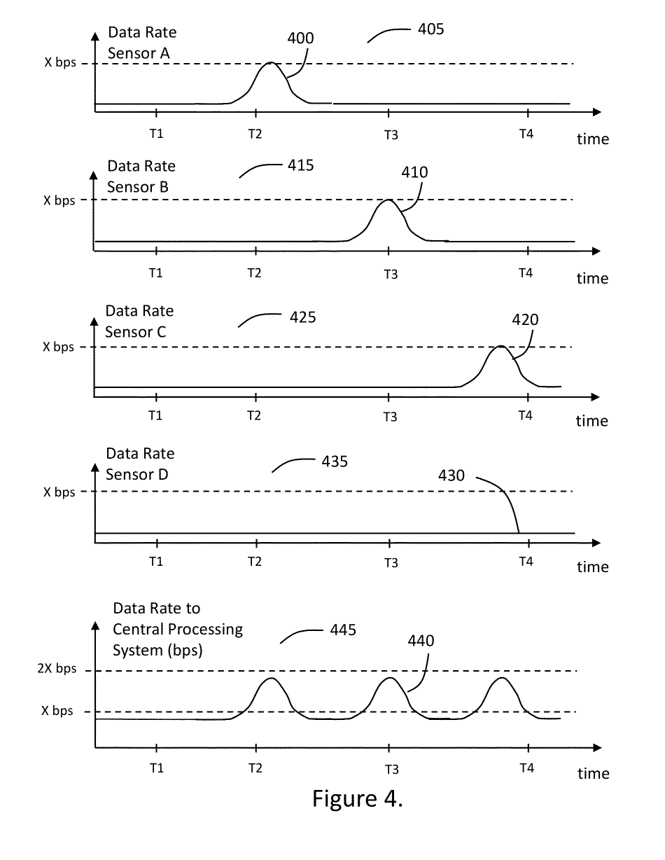

This process is also illustrated in FIG. 4 from the perspective of data rate generated and transmitted by each of the sensor nodes. In FIG. 4, view 405, line 400 represents the data rate generated by sensor node A as the density transition propagates past sensor node A. FIG. 4, view 415 captures this data rate change for sensor node B with line 410. FIG. 4, view 435 illustrates this data rate change with line 420 as the density pulse approaches sensor C. Over the time period of this example, the density transition does not reach sensor node D's sensing region and as such, the data rate from sensor node D does not substantially vary from the steady-state rate of Y bps (=0.2X bps) over the time period illustrated. This is illustrated as line 430 in FIG. 4, view 435.

It is assumed in this simple example that the physical sensing regions of each sensor node are substantially non-overlapping. As a result, the time periods at which each sensor node requires a higher data rate are substantially non-overlapping. The data collected, generated and forwarded by sensor node A can be plotted as in line 440 in FIG. 4, view 445 as the sum of the individual sensor node data rates. In this simple example, the 2X bps maximum rate is never exceeded and no data is lost despite the fact that the array of sensors could generate 4X bps. This simple example is intended to demonstrate that data collection from an array of sensors can be scheduled to track time moving source(s) of higher data rate requirements. This tracking can be used to efficiently de-allocated bandwidth from sensors no longer requiring a higher bandwidth and allocate this bandwidth to sensors and busses requiring the bandwidth data rate to communicate the consequences of the event propagating through the physical system to which the sensor array is connected. The ideas of employing a priori knowledge of the sensor structure and the system to which the sensor array is attached, and to model and predict the change in location versus time of data generating events, can be readily extended to more complex structures. These sensor structures may or may not include time overlap of sensed events, multiplicity of sensed events and actions and other sources of data generating processes.

From a systems perspective, there are multiple ways to effectively utilize available data communications bandwidth in order to maximize the quality of the data transferred through the sensor network. One basic technique is to dynamically allocate additional bandwidth to the sensor nodes generating an increased data rate and reduce the allocated bandwidth to sensor nodes not requiring the increased data rate. Taught in this patent disclosure is the process of monitoring changes in data transmission requests and by exploiting knowledge concerning the physical layout of the sensor network, the structure to which the sensor network is attached and the processes the sensor nodes are monitoring, to predictively allocate and de-allocate bandwidth to sensors as the need arises.

As illustrated in FIG. 3, knowledge of pipeline dynamics, together with sensor spacing and sensor dynamics allow the accurate prediction in time of when the change in density will be observable by specific sensors in the network as the density change moves through the pipeline. This allows the system to dynamically allocate and de-allocate bandwidth to various sensors as the event propagates through the pipeline and interacts with these various sensors, thus allowing a more efficient use of communications bandwidth. This enables the use of less expensive communication systems or the connection of more sensors on a single communications system.

Many other types of events are possible in a system. In some cases, these events will start as localized disturbances, (a wrench dropped on a pipe, a box of product slipping off a conveyor belt) which propagates through the physical structure. As this event propagates through the system, various sensors will detect the generated signals. Networks are typically designed with some margin to accommodate these transient signals. As the event reaches various sensors, these sensors temporarily ramp up to a higher data rate for the time while the event is detectable by the sensor and then the sensor drops back to the lower data rate. In a top-down management system, the central processing system can monitor the propagation of this event, and knowing the physical structure and dynamics of the combined structure and sensor network, predict propagation of the event and appropriately schedule data bandwidth on various sensors and buses as the event moves through the system. In a decentralized approach, the various sensors may have to negotiate data rate with neighboring sensors based on some set of commonly known rules.

Another method employed for effective utilization of network bandwidth is the use of data compression schemes. As a general rule, compression methods are either lossy or lossless. In the lossless case, an exact reproduction of the original data can be recovered from the compressed data stream. With lossy compression methods, the signal recovered from the compressed data stream will represent the original signal in specific statistical or dynamic measures and will not necessarily be an exact reproduction. Clearly, either of these data compression methods can be used with the sensors in these networks to aid in the reduction of bandwidth requirements. In a simple case of employing a 4:1 lossless compression scheme on all sensors, all the time, an approximate 4X improvement in communications efficiency can be realized. This can be used to either increase the number of sensors on a given bus, enable the use of a lower bandwidth and typically less expensive bus or some combination of both.

A more effective technique is to combine the predictive bandwidth allocation methods taught in previous paragraphs, with compression. In application of these concepts to a sensor network, the bandwidth allocation mechanism now has an additional lever to work with in the allocation of system bandwidth. By altering the compression rates (and quality of the represented data) employed at various sensor nodes to communicate the data collected at these various nodes, significant additional bandwidth can effectively be created in a network. As a general rule, lossy compression methods provide substantially larger compression rates than lossless. As an aid in explanation, assume a lossless compression rate of 4:1 and a lossy compression rate of 20:1. The specific compression schemes employed are not critical to the intent of this patent. Specific compression rates may vary considerably from the example rates employed in this discussion.

In the example of FIGS. 3 and 4, two compression philosophies will be compared for the purpose of illustrating the methods. In some cases, lossless techniques are employed with signals containing large changes in dynamics or statistics and lossy methods employed with signals with lower dynamic changes. The assumption is that the high dynamic changes in signal structure contain the important information and the compressed data representing these changes must preserve the original signal structure in the best possible way. This effectively demands the use of lossless compression schemes for the changing data. Conversely, the steady-state and statistically stationary signals, have likely been well characterized by the data collected over the (relatively) long period of steady-state behavior. With known characteristics of the steady-state signal, there is little new information to communicate. As such, lower data rates and likely a higher compression rate can be tolerated. Lossy techniques can likely be used since the signal is well known as in the steady-state case. This is compression philosophy case 1.

In an alternate philosophy, the assumption is made that large changes in signal dynamics are easy to measure and making “small” errors in the estimation of these large changes has little impact on tracking and recording the properties of the event that is propagating through the sensor network. A lossy compression method can be employed and still preserve the essential information of the event. On the other hand, monitoring the steady-state signal characteristics may well depend on accurately reporting details of the small signal dynamics and may require a high-fidelity lossless compression scheme in order to preserve the details in these steady-state signals. This is compression philosophy case 2. The point of this discussion is to illustrate that depending on the specific details of the signals to be communicated, either a lossy or lossless compression technique may be employed to compress sensed measures of the event signal as it propagates through a system measured with sensors. Lossy or lossless compression methods may be required to compress the steady-state signals. Additionally, the same lossy or lossless scheme may be employed on all signals at all times.

Assume a 20:1 compression rate for the lossy method and 4:1 compression rate for the lossless method. Further assume only one sensor at a time experiences the dynamic change (event) in signal statistics as this propagates through the system. In case 1: Lossless compression is used for the event as it propagates through the systems and and lossy compression techniques are employed for the steady-state condition. Reconsider the four sensor example in FIGS. 2 and 3 and Y bps is the nominal data rate generated by a sensor in the steady-state mode and X bps is the data rate generate by a sensor when and event is occurring, and Y bps=0.2X bps.

Under steady-state conditions, all sensors in the network are employing a 20:1 (lossy) compression rate and the total data rate on bus 220 in FIG. 2 is 3×Y bps/20 or 0.03X bps. The total data rate on bus 225 is 4×Y bps/20 or 0.04X bps. As a dynamic change signal propagates through the network, one sensor will require 1 X bps which is compressed losslessly at a 4:1 rate. The maximum data rate on bus 220 is therefore 2×Y bps/20+1×X bps/4 or 0.27X bps. Assuming the maximum data rate allowed on bus 220 is 2 X bps and only 1 sensor at a time will need to run at the X bps (pre-compression rate), 175 sensors could be placed on bus 220 before reaching the 2X bps rate maximum (1X bps/4+175Y bps/20=0.25X bps+175×0.2X bps/20=0.25X bps+1.75X bps=2X bps. In this simple example, the use of prediction in the allocation of compression rates increased the number of sensors manageable on bus 220 from 4 to 175. This is of significant economic value.

Assuming case 2, lossless for the steady-state condition and lossy for the dynamic change, the system maintains an average 4:1 compression rate during steady-state operations. In this mode, the 3 sensors generate 3Y bps/4 or 0.150X bps. With one sensor responding to a dynamic change, the total rate on the bus is X bps/20+2Y bps/4=0.150X bps. The average rate has not changed. In this case, 39 sensors could be placed on bus 220 before exceeding the 2X bps maximum data rate. Clearly the combination of system wide data rate or bandwidth management combined with compression schemes can provide large increases in the number of sensors deployable on a given communications bus. It is also obvious that data compression methods can be used without the use of the data rate prediction and management techniques discussed in this patent.

In many cases, the data collected by the sensor network is used to control certain operations in the system to which the sensor network is attached. An example may be a system of pipelines and pumps delivering consumables and raw material to a chemical processing plant and transporting processed product. Several specific signals collected by the sensor network may be used by various control systems to maintain specific flow rates, pressures, temperatures, etc. Purposeful or accidental corruption of this data could have detrimental effects on the system. Illicit collection of system information could provide strategic advantages to competitors. Encryption of the data collected by the sensors can be employed to significantly hamper these sorts of inappropriate actions. Discussed next is the inclusion of data encryption techniques with the compression and data rate management methods previously disclosed. It is also obvious that encryption techniques can be used independent of the data rate prediction and management schemes and/or compression methods.

For the purposes of this patent disclosure, encryption methods can be characterized either as encrypting N bits with N bits or encrypting N bits with M bits (M>N). These two cases will be referred to as the 1:1 and the N:M cases. Systems employing N:M schemes are generally more secure than those implementing 1:1 schemes. As a result of the effective bandwidth gain realized with the compression approaches previously described, the more secure N:M methods can be employed at lower cost than without use of compression. Additionally, the increased bandwidth available as a result of compression and data rate management can also be employed for dynamic modification of encryption methods or keys providing yet more security to the transmitted data.

These disclosed data rate monitoring and allocation processes can be implemented either in a centralized top-down approach, in a de-centralized approach or in some combination. Since the specific details of the implementation of data rate management are substantially independent of the specifics of the relevant communications structure and do not directly impact the concepts taught in this patent disclosure, these methods of bandwidth management, compression and encryption are substantially independent of the specific communications or bus systems employed.

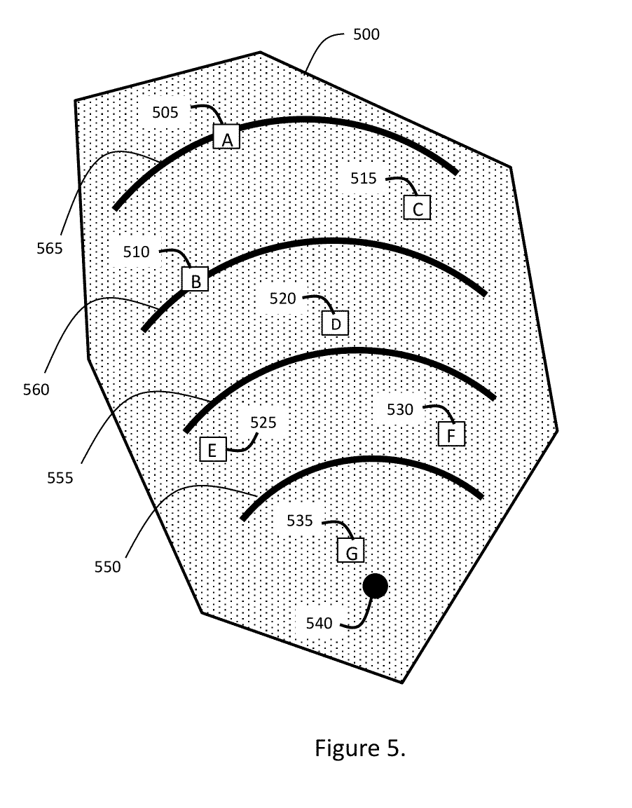

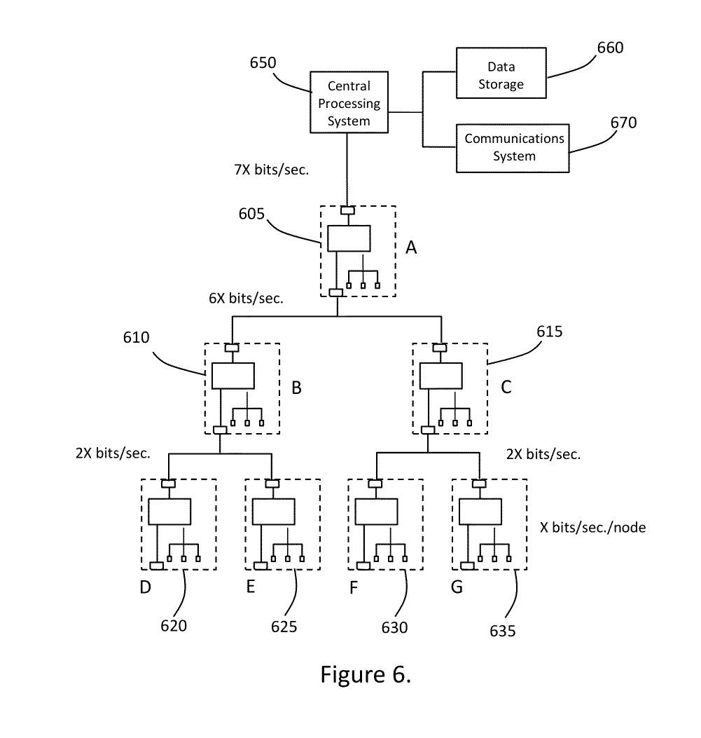

FIGS. 5 and 6 illustrate another embodiment of this invention. FIG. 5 illustrates the sensor array distributed across a multi-dimensional structure. Sensors A 505, B 510, C 515, D 520, E 525, F 530 and G 535 in FIG. 5 correspond to sensors 605-635 respectively in FIG. 6. A disturbance, possibly originating at a location indicated by 540 in FIG. 5 generates a vibrational wave front that propagates through the structure 500. This wave front is indicated as line 550 at time T1, as line 555 at time T1>T2, as line 560 at time T3>T2 and as line 565 at time T4>T3. As this wave front propagates through the structure, first sensor G 535 is impacted by this vibrational event. Sometime later, sensors E 525 and F 530 have the wave pass by their locations. At various other times, the wave front passes by sensors D 520, C 515, B 510 and A 505. Methods discussed in this patent enable these various sensors to efficiently communicate the details and progress of this disturbance through the structure. It should also be obvious that with knowledge of the structure and the arrangement of sensors, that a central processing system 650 in FIG. 6 can anticipate the arrival of the disturbance at various sensors and allocate, in advance of the arrival of the disturbance, appropriate data rate, compression schemes and encryption methods.

The objective of this previous discussion is to illustrate that these methods may be employed in arbitrary structures and are not limited to pipelines. The use of the pipeline example is for explanation purposes only and is not intended to limit application of these methods to any specific system or structure.

Processing elements contained in sensor elements 610 and central processing system 650 in FIG. 6 may be any integrated circuit device configured for a particular purpose. As such, the processing element contained in 610 and central processing system 650 may be any application specific integrated circuit (ASIC), microprocessor, or other logic device known in the art or developed in the future.

The previous discussion is not intended to limit the specific numbers, types and arrangements of sensors, the specific data rate management, data compression or data encryption techniques employed. References to specific techniques are used only as a means to explain an example of the art. Those skilled in these methods are aware of many alternate methods that can be employed.

In summary, systems, devices, and methods configured in accordance with exemplary embodiments relate to:

A physical structure augmented with several sensors or sensor nodes, coupled in some communications network in which the known dynamics of the physical structure and associated sensor array allows for the purposeful allocation of data rate among sensors and communications network in order to more effectively utilize available system bandwidth. In certain embodiments, the sensors may be one or more of an accelerometer, gyroscope, pressure, acoustic, temperature, magnetic, optical, torsion, tension or force measuring devices.

The sensor and physical structure as described above in which data rate communications and data processing and communications allocations are made based on the predictable propagation of the sensor detectable signals through the physical network.

The sensor and physical structure as described above in which data rate communications and data processing allocations are made as a result of detecting an event, tracking initial progress through the network and then predicting future propagation and the requirements of various sensors and communications systems as the event propagates through the system.

The sensor network attached to some physical structure as described above in which data compression techniques are used in conjunction with bandwidth allocation methods. These data compression methods may include combinations of lossy and lossless methods which are dynamically selected in order to efficiently communicate the event across the sensor array and communications network.

The sensor network attached to some physical structure as described above in which data compression techniques are used without bandwidth allocation methods. These data compression methods may include combinations of lossy and lossless methods which are dynamically selected in order to efficiently communicate the event across the sensor array and communications.

The sensor network attached to some physical structure as described above in which data encryption methods are employed in conjunction with data compression and data rate allocation methods. Use of these methods allows the use of stronger encryption schemes than would be possible without the use of both data rate allocation and compression control methods.

The sensor network attached to some physical structure as described above in which data encryption methods are employed with or without out data compression and with or without data rate allocation methods.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention.

What is claimed is:

1. A data acquisition and processing system integrated into a physical structure comprising:
at least two sensing nodes networked together in a manner enabling a digital processing system to acquire data generated by the sensing nodes and communicate results of processing this data to remote systems;
said sensing nodes incorporate one of an accelerometer, gyroscope, pressure, acoustic, temperature, magnetic, optical, torsion, tension and force measuring devices;
said sensing nodes are physically distributed on said physical structure in such a manner that said sensing nodes sample propagating mechanical waves in said physical structure; and
said sensing nodes contain processing capabilities enabling the compression of sensor data prior to communication to other sensing nodes for possibly alternate compression methods and possibly forwarded to a central processing system.

2. The data acquisition and processing system integrated into a physical structure as described in claim 1 further comprising capabilities to encrypt the data generated at each sensing node prior to communication of this data to other sensing nodes for possibly alternate encryption methods and possibly forwarded to a central processing system.

3. A data acquisition and processing system integrated into a physical structure comprising:
at least two sensing nodes networked together in a manner enabling a digital processing system to acquire data generated by the sensing nodes and communicate results of processing this data to remote systems;
said sensing nodes incorporate one of an accelerometer, gyroscope, pressure, acoustic, temperature, magnetic, optical, torsion, tension and force measuring devices;
said sensing nodes are physically distributed on said physical structure in such a manner that said sensing nodes sample propagating mechanical waves in said physical structure; and
said sensing nodes are arranged on said physical structure and networked together in manners such that a fixed data bandwidth allocation method providing specific bandwidths to specific sensing nodes can efficiently collect data without the need for dynamic allocation of communication bandwidth.

4. The data acquisition and processing system integrated into a physical structure as described in claim 3 further comprising capabilities to compress the data generated at each sensor node prior to communication of this data to other sensing nodes for possibly alternate compression methods and possibly forwarded to a central processing system.

5. The data acquisition and processing system integrated into a physical structure as described in claim 3 further comprising capabilities to encrypt the data generated at each sensor node prior to communication of this data to other sensing nodes for possibly alternate encryption methods and possibly forwarded to a central processing system.

6. A data acquisition and processing system integrated into a physical structure comprising:
at least two sensing nodes networked together in a manner enabling a digital processing system to acquire data generated by the sensing nodes and communicate results of processing this data to remote systems;
said sensing nodes incorporate one of an accelerometer, gyroscope, pressure, acoustic, temperature, magnetic, optical, torsion, tension and force measuring devices;
said sensing nodes are physically distributed on said physical structure in such a manner that said sensing nodes sample propagating mechanical waves in said physical structure; and
data processing methods to predict, based on known structural dynamics of said structure and known positions of said sensing nodes, the propagation of mechanical waves and the timing of these mechanical waves interacting with said sensing nodes, and adjusting the bandwidth allocated to various said sensor nodes in response to this propagating mechanical wave.

7. The data acquisition and processing system integrated into a physical structure as described in claim 6 further comprising capabilities to adjust the compression rates and methods performed in various said sensing nodes in response to the predicted propagation of a mechanical wave through said structure, this compressed data then forwarded to other sensing nodes for possibly alternate compression methods and possibly forwarded to a central processing system.

8. The data acquisition and processing system integrated into a physical structure as described in claim 6 further comprising capabilities to adjust the encryption methods performed in various said sensing nodes in response to the predicted propagation of a mechanical wave through said structure, this encrypted data then forwarded to other sensing nodes for possibly alternate encryption methods and possibly forwarded to a central processing system.

9. The data acquisition and processing system integrated into a physical structure as described in claim 6 further comprising capabilities to adjust the compression rates and methods and encryption methods performed in various said sensing nodes in response to the predicted propagation of a mechanical wave through said structure, this compressed and possibly encrypted data then forwarded to other sensing nodes for possibly alternate compression and alternate encryption methods and possibly forwarded to a central processing system.
